(19) United States
(12) Patent Application Publication
(10) Pub. No.: US 2006/0126195 A1
(43) Pub. Date: Jun. 15, 2006

(54) Device for receiving an optical module in an imaging unit

(76) Inventors: Johannes Rau, Gerstetten (DE); Armin Schoeppach, Aalen (DE); Bernhard Geuppert, Aalen (DE)

Correspondence Address: WELLS ST. JOHN P.S., 601 W. FIRST AVENUE, SUITE 1300, SPOKANE, WA, 99201, US

(21) Appl. No.: 10/523,598

(22) PCT Filed: Jul. 7, 2003
(86) PCT No.: PCT/EP03/07257

§ 371 Date: Oct. 12, 2005

(30) Foreign Application Priority Data
Aug. 8, 2002 (DE) 102 36 321.8
Apr. 11, 2003 (DE) 103 16 589.4

(51) Int. Cl. G02B 7/02

(52) U.S. Cl. 359/819

(57) ABSTRACT

An apparatus is used for holding an optical assembly in an imaging device which has a number of optical assemblies. The optical assembly is suspended via at least one decoupling element in at least one area in a supporting structure. The resultant effect of the at least one decoupling element in the at least one area is to impede possible movement, in terms of rotation or translation, in at least one suitable one of three orthogonal spatial directions, thus resulting in at least one statically defined bearing.

### BACKGROUND OF THE INVENTION

1. Field of the Invention

The invention relates to an apparatus for holding an optical assembly in an imaging device which has a number of optical assemblies, in particular for holding a lens group in an objective.

2. Description of the Related Art

Various optical imaging devices, such as objectives, telescopes or the like, which are composed of a number of optical assemblies are known from the general prior art. In order to ensure adequate functionality, the individual optical assemblies must in this case be positioned in a fixed arrangement with respect to one another. The individual assemblies must therefore be held in very stable positions with respect to one another. This also applies in particular to catadioptric imaging devices, that is to say those which have lenses in some of their assemblies, and lenses and/or mirrors in other assemblies.

In principle, it is also known from the general prior art for each of the assemblies to have a so-called neutral point. This means that this point is neutral with respect to the optical sensitivity, such that a small rotation of the assembly about this point does not produce any image offset. Although it may in principle be possible to design each individual one of the optical assemblies in such a way that it could rotate about the neutral point through sufficiently small angles, this would, however, have the serious disadvantage that it would necessitate very complex bearings, and that the stiffness of the overall imaging device would suffer in consequence.

### SUMMARY OF THE INVENTION

The object of the invention is thus to provide a suspension for an assembly in an imaging device which has adequate stiffness without in the process resulting in a force, which is produced by heating or the like, on its supporting structure, and which, furthermore, is designed such that a rotation point for the first oscillation form is located at least approximately in the area of a neutral optical point of the assembly.

According to the invention, this object is achieved in that the optical assembly is suspended via at least one decoupling element in at least one area in a supporting structure, wherein the resultant effect of the at least one decoupling element in the at least one area is stiff in terms of rotation or translation in at least one suitable one of three orthogonal spatial directions, thus resulting in at least one statically defined bearing.

The “or” between rotation and translation should in this case be understood as meaning on the one hand a choice between rotation and translation and on the other hand a combination of rotation and translation.

The solution according to the invention thus offers the advantage that the assembly can intrinsically be designed to be very stiff and is then suspended via the at least one decoupling element, which, for example, has radially soft spring elements, in which case the assembly can likewise additionally be held on a second plane, for example via tangentially stiff but axially soft spring elements. The position of the two suspension points with respect to one another and the stiffness of the decoupling elements which can be chosen in the design also make it possible to ensure that a first natural frequency is sufficiently high, and that the associated first natural form rotates about the neutral point of the optical assembly. The decoupling elements also compensate for thermally different expansions resulting from temperature and material differences between the optical assembly and supporting structure in which the optical assembly is suspended, to the extent that they do not lead to damaging forces either in the vertical or radial directions.

Further advantageous refinements of the invention are contained in the dependent claims and will become clear in the following text using an exemplary embodiment which will be explained with reference to the drawings.

### BRIEF DESCRIPTION OF THE DRAWINGS

FIG. 1 shows an outline illustration of projection exposure system for microlithography, which can be used for exposure of structures on wafers which are coated with photosensitive materials;

FIG. 2 shows an outline illustration of a first embodiment of the apparatus according to the invention;

FIG. 3 shows an outline illustration of an example of a catadioptric imaging device;

FIG. 4 shows an outline illustration of the method of operation of a second suspension according to the invention;

FIG. 5 shows an outline illustration of one embodiment of the apparatus according to the invention as illustrated in FIG. 4; and

FIG. 6 shows a plan view of an alternative embodiment of the apparatus according to the invention.

### DETAILED DESCRIPTION

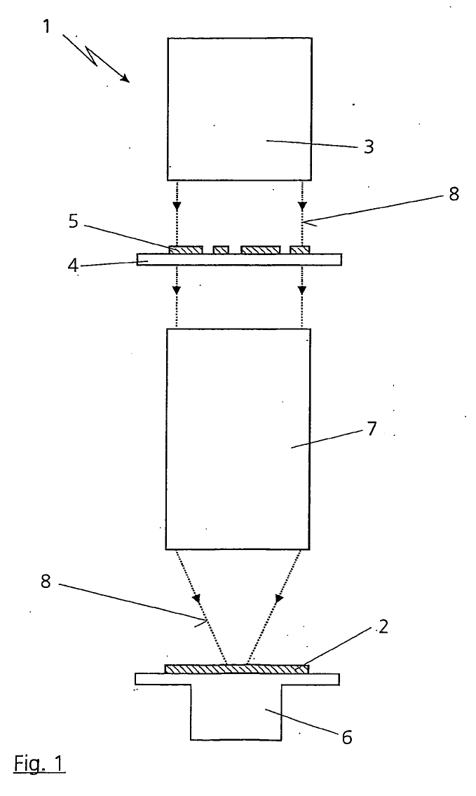

FIG. 1 shows a projection exposure system 1 for microlithography. This is used for exposure of structures on a substrate which is coated with photosensitive material and is generally composed predominantly of silicon and is referred to as the wafer 2, for production of semiconductor components, such as computer chips.

The projection exposure system 1 in this case essentially comprises an illumination device 3, a device 4 for holding and exact positioning of a mask which is provided with a grid-like structure, a so-called reticle 5, by means of which the subsequent structures on the wafer 2 are defined, a device 6 for holding, moving and exact positioning of this actual wafer 2, and an imaging device, specifically a projection objective 7.

The basic principle of operation provides for the structures which have been introduced into the reticle 5 to be exposed on the wafer 2, in particular with the size of the structures being reduced to a third or less of the original size. The requirements for which the projection exposure system 1, in particular the projection objective 7, is subject with regard to resolutions are in this case in the order of a few nanometers.

Once the exposure process has been carried out, the wafer 2 is moved onwards so that a large number of individual fields, in each case with the structure predetermined by the reticle 5, are exposed on the same wafer 2. Once the entire surface area of the wafer 2 has been exposed, it is removed from the projection exposure system 1 and is subjected to a number of chemical treatment steps, in general to etching removal of material. If required, a number of these exposure and treatment steps are carried out successively, until a large number of computer chips are produced on the wafer 2. Because of the step-by-step forward movement of the wafer 2 in the projection exposure system 1, this is frequently also referred to as a stepper.

The illumination device 3 produces a projection beam 8, which is required for imaging of the reticle 5 on the wafer 2, for example, light or similar electromagnetic radiation. A laser or the like may be used as the source for this radiation. The radiation is shaped via optical elements in the illumination device 3 such that the projection beam 8 has the desired characteristics in terms of diameter, polarization, shape of the wavefront and the like on striking the reticle 5.

An image of the reticle 5 is produced via the projection beam 8 and is transferred by the projection objective 7 on an appropriately reduced scale to the wafer 2, as has already been explained above. The projection objective 7 in this case is formed from a large number of individual refractive and/or reflective optical elements, such as lenses, mirrors, prisms, closure plates and the like.

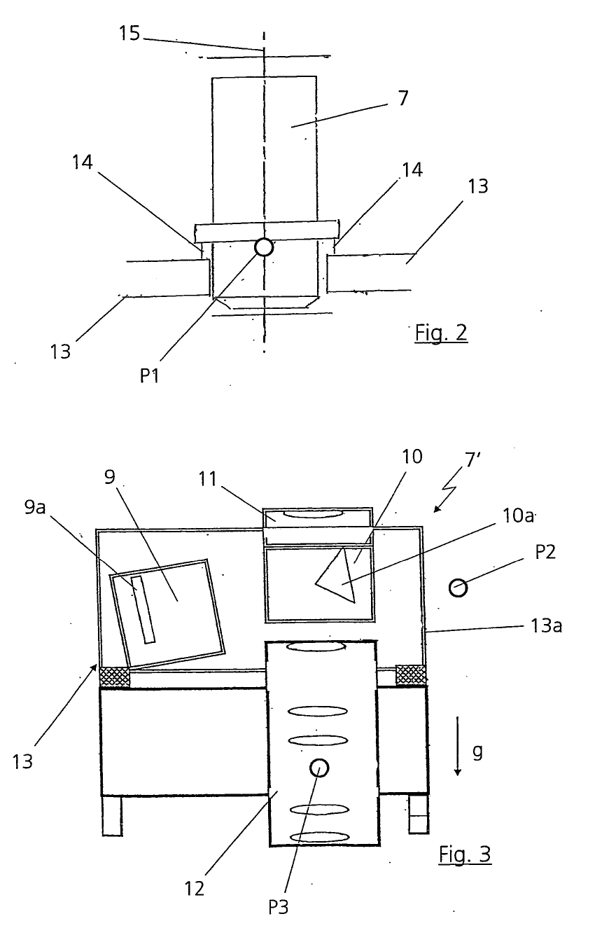

FIG. 2 shows a purely refractive objective 7, which is held and fixed on a supporting structure 13 via decoupling elements 14 in only one area in the vicinity of a neutral point P1 or at the neutral point P1. The decoupling elements 14 first allow a bearing which allows different thermal expansions and position tolerances between the objective 7 and the supporting structure 13 without introducing unacceptable forces into the objective 7. Furthermore, the decoupling elements 14, which are in the form of spring elements, allow as a first oscillation form a rotation which is as pure as possible to be generated or to be produced about the neutral point P1. This could be not only a tilting movement about any given axis orthogonally with respect to an optical axis 15, but also a tumbling movement about the objective axis 15 (which corresponds to the optical axis) and about the neutral point P1.

Since the objective 7 thus in its first natural form carries out a rotary movement about an axis through the neutral point P1 and orthogonally with respect to the objective axis 15, only a small amount of image vibration can be expected from this natural form. Since the contribution of the objective oscillation form to the image vibration is small, the objective 7 can oscillate with a higher amplitude.

Fixing of the objective 7 on only one plane also has further significant advantages. The thermal expansion in the axial direction (in the z direction) is not impeded by such suspension. Furthermore, the objective 7 can be installed in its supporting structure 13 easily and at low cost.

FIG. 3 shows a projection objective 7 such as this as illustrated in FIG. 1, which in this specific case is in the form of a catadioptric objective 7′, that is to say with reflective and refractive optical elements.

The catadioptric objective 7′ as illustrated in FIG. 3 in this case has four optical assemblies or subassemblies 9, 10, 11, 12. The first assembly 9 in this case has a mirror 9a as well as horizontal lenses, which are not illustrated. The second assembly 10 has a double mirror 10a, while the third assembly 11 has lenses. A number of lenses can be seen in the fourth assembly 12, which is of interest for the invention described here, with these lenses being arranged such that the optical axis of the optical assembly 12 runs at least approximately in the same direction as the force of gravity g, so that the assembly 12 is thus also referred to as a vertical lens group.

In catadioptric objectives 7′ such as these, these individual assemblies or subassemblies 9, 10, 11, 12 must now be kept in a very stable position with respect to one another. In principle, there are two conceivable approaches for this purpose. Firstly, the retention for the individual assemblies 9, 10, 11, 12 in the supporting structure 13 of the catadioptric objective 7′ can be designed to be sufficiently stiff that they are always kept in a stable position with respect to one another. This is undoubtedly possible in some cases, but depends on the precise conditions in the individual groups. In the exemplary embodiment described here, this is intended to be done in the upper part 13a of the supporting structure 13, which surrounds the assemblies 9, 10, 11.

Adequate stiffness of the suspension can be ensured only with difficulty for the comparative complex and heavy assembly 12, specifically the vertical lens group. However, each optical system and thus each of the optical assemblies 9, 10, 11, 12 as well have a so-called neutral point, as has already been explained with reference to FIG. 2. This so-called neutral point defines a point about which a small rotation of the components does not produce any image offset. The points are thus neutral with respect to the optical sensitivity. In the exemplary embodiment illustrated in FIG. 3, these points are, for example, the point identified by P2 for the assembly 9, and the point identified by P3 for the assembly 12. The solution described in the following text here makes it possible to achieve increased stiffness for the link, and to place the location of the rotation point for the first oscillation form in the vicinity of the neutral point of the assembly 12.

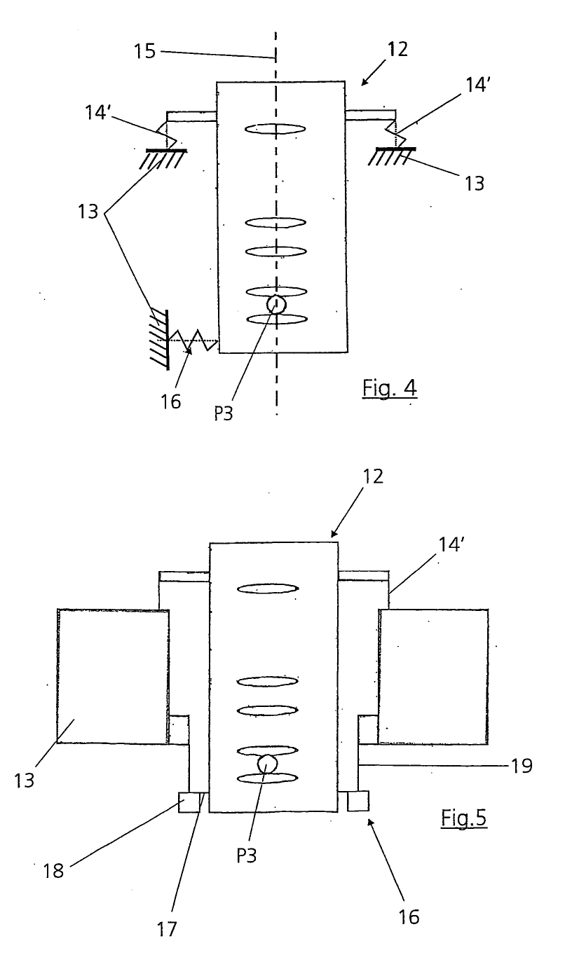

FIG. 4 shows the assembly 12 as mentioned above, and the fundamental method of operation of the suspension will be explained here using a two-dimensional analysis.

The assembly 12 is suspended in an outer area via decoupling elements 14′, which are indicated here in principle as springs with the spring stiffness C1. The decoupling elements 14′ in this case connect the assembly 12 and the supporting structure 13, which is not illustrated in any more detail here.

If the optical axis of the assembly 12 is assumed to be the z axis 15, the decoupling elements 14′ are designed with the spring stiffness C1 such that they hold the assembly 12 securely in the axial direction, that is to say in the direction of the z axis 15. The assembly 12 is fixed orthogonally with respect to the z axis 15 via further decoupling elements 16 with the spring stiffness C2 in another area of the assembly 12.

The decoupling elements 14′ which are, for example, in the form of leaf springs have been illustrated in an idealized form in the exemplary embodiment illustrated in FIG. 4 as springs with high stiffness in the z direction. In contrast, the stiffness in the radial and tangential directions was regarded as being very small, and thus negligible. As a result of being coupled via a membrane, the decoupling elements 16 can produce only horizontal stiffness. A first resonant frequency can thus be achieved for the entire arrangement by matching the spring stiffnesses C1 and C2 and by the position of the springs in the corresponding areas of the assembly 12, which is sufficiently high, for example above 500 Hz and at the same time has an associated oscillation form which is expressed by a rotation about the neutral point of the assembly 12, which is identified by P3.

A more detailed exemplary embodiment is now illustrated in FIG. 5.

Once again, this figure shows the assembly 12, a part of the supporting structure 13 and the decoupling elements 14′, 16. The supporting structure 13 is, for example, in the form of a structure which can be machined very accurately. The assembly 12 can thus be coupled via decoupling elements 14′ which are in this case axially very stiff, but are radially soft and are tangentially less stiff.

In the second area of the assembly 12, in which the second decoupling elements 16 are illustrated, these are now designed in a less complex form than illustrated in an idealized form in the previous example of the principle.

The decoupling elements 16 are formed by a radially stiff and axially soft membrane 17, which is attached to a circumferential stiff ring 18 and holds the assembly 12 radially in position without this leading to axial forces, since the membrane 17 is designed to be soft in the direction of the z axis 15.

The stiff ring 18 is now connected to the supporting structure 13 via further spring elements 19, which are radially soft and are stiff in the axial and tangential directions. The design with the two decoupling elements 14′, 16 in this case results in far greater stiffness in terms of rotation than a conventional single-flange solution, and can also be designed by virtue of the spring stiffnesses that are used and the exact position of the decoupling elements 14′, 16 such that a first natural frequency is sufficiently high, for example above 500 Hz. The associated oscillation form at this natural frequency in this case rotates approximately about the neutral point P3 of the assembly 12.

Furthermore, the problems of thermal expansion of the holders for the assembly 12 with respect to the supporting structure 13 are decoupled via the decoupling elements 14′, 16 such that the different thermal expansions do not lead to radial or axial forces which could damage the assembly 12.

In addition, the decoupling elements 14′ need not additionally be arranged vertically, as illustrated here. Variants are also feasible in this case in which the corresponding decoupling elements 14′ are positioned obliquely (not illustrated). It is thus possible to create a rotation point for adjustment purposes about which the assembly 12 can be rotated while not being fixed in the second area, that is to say in the area of the decoupling elements 16. Once the correct installation position has been reached, it can then be fixed in the area of the decoupling elements 16.

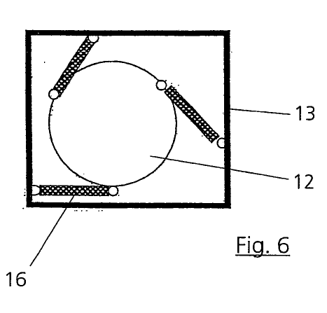

FIG. 6 now shows a further embodiment which illustrates that the solution described above comprising a membrane 17, a stiff ring 18 and a spring element 19 would not be the only feasible approach for the decoupling elements 16. The decoupling elements 16 illustrated in FIG. 6 are in the form of three rods which act tangentially and are connected to the assembly 12 via solid joints.

This thus results in a design with a comparable function to that which is feasible by means of the decoupling elements 16 comprising a membrane 17, a stiff ring 18 and spring elements 19, with this design occupying considerably less physical space than the previously described solution, by means of the three tangentiallylacting decoupling elements 16.

What is claimed is:

1. An apparatus for holding an optical assembly in an imaging device which has a number of optical assemblies, wherein the optical assembly is suspended via at least one decoupling element in at least one area in a supporting structure, wherein the resultant effect of the at least one decoupling element in the at least one area is to impede possible movement in terms of rotation or translation in at least one suitable one of three orthogonal spatial directions, thus resulting in at least one statically defined bearing.

2. The apparatus as claimed in claim 1, wherein said optical assembly is suspended via said decoupling elements in at least two different areas in said supporting structure, wherein the resultant effect of said decoupling elements in each area is stiff in terms of rotation or translation in at least one suitable one of three orthogonal spatial directions, thus resulting in at least one statically defined bearing.

3. The apparatus as claimed in claim 2, wherein said imaging device is an objective in the form of a catadioptric objective for a projection exposure system for microlithography.

4. The apparatus as claimed in claim 3, wherein said optical assemblies are a lens group.

5. The apparatus as claimed in claim 2 or 3, wherein said decoupling elements in the one area in which the load is passed to said supporting structure is stiff in the spatial direction at least approximately parallel to the force of gravity (g), wherein said optical assembly is suspended in the other area in said supporting structure via a combination of tangentially stiff decoupling elements and a membrane.

6. The apparatus as claimed in claim 2, wherein the tangentially stiff decoupling elements and the membrane are connected via a stiff intermediate element.

7. The apparatus as claimed in claim 1 or 2, wherein said decoupling elements are in the form of leaf spring elements.

8. The apparatus as claimed in claim 2, wherein said decoupling elements are stiff in the spatial direction at least approximately parallel to the force of gravity (g) in the one area in which the load is transmitted to said supporting structure, wherein the suspension of said optical assembly in said supporting structure in the other area is provided via a large number of tangentially stiff, axially and radially soft elements.

9. The apparatus as claimed in claim 7 or 8, wherein the position of the areas, the alignment of said leaf spring elements and the spring stiffness of said leaf spring elements are chosen such that a first natural form of the oscillation rotates about a point (P3) on said assembly which is neutral with respect to optical sensitivity.

10. The apparatus as claimed in one of claims 1 or 2, wherein said decoupling elements are chosen such that thermal expansions between said supporting structure and said assembly do not lead to mechanical forces.

11. Use of an apparatus as claimed in claim 1 in a projection exposure system for microlithography.
